(19) United States
(12) Patent Application Publication
(10) Pub. No.: US 2013/0166164 A1
(43) Pub. Date: Jun. 27, 2013

(54) GEAR SELECTION DEVICE FOR A MOTOR VEHICLE

(71) Applicant: GM Global Technology Operations LLC, Detroit, MI (US)

(72) Inventor: Marco Moebus, Mainz (DE)

(73) Assignee: GM GLOBAL TECHNOLOGY OPERATIONS LLC, Detroit, MI (US)

(21) Appl. No.: 13/717,540

(22) Filed: Dec. 17, 2012

(30) Foreign Application Priority Data
Dec. 17, 2011 (DE) 102011121398.1

(51) Int. Cl. F16H 59/66

(52) U.S. Cl. CPC F16H 59/66
USPC 701/65

(57) ABSTRACT

A gear selection device for a motor vehicle is provided. The gear selection device includes a logic unit which is equipped in order to determine a gear to be engaged in a transmission of the motor vehicle by means of at least one variable connected to the load of an engine of the motor vehicle, and an ambient area sensor. The gear selection device is equipped in order to take into account information supplied by the ambient area sensor relating to the road located in front of the vehicle with the outputting of a selection signal specifying a newly determined gear.

### CROSS-REFERENCE TO RELATED APPLICATION

This application claims priority to German Patent Application No. 10 2011 121 398.1, filed Dec. 17, 2011, which is incorporated herein by reference in its entirety.

### TECHNICAL FIELD

The present disclosure relates to a gear selection device for selecting a gear to be engaged in a change-speed transmission of a motor vehicle.

### BACKGROUND

Automatic change-speed transmissions, wherein a mechanical-hydraulic logic unit determines the gear to be engaged in operation by means of variable such as engine rotational speed, engine torque, travelling speed, etc. linked to the load of the engine have been known for decades. In recent times, logic units in the form of electronic circuits have emerged in connection with automated change-speed transmissions. Like the conventional mechanical/hydraulic logic units, the electronic logic units also serve for determining a gear of the transmission suited to the respective engine load so that a low fuel consumption is achieved. The advantage of the electronic logic unit substantially lies in that the relationship between engine load and determined gear can be more easily varied and adapted to different models of motor vehicles or engines than with a mechanical/hydraulic logic unit and that complex dependencies of the gear selection on various influence factors can be easily implemented. When the driver of a motor vehicle reacting to changes of the traffic situation surrounding him carries out control maneuvers such as for example accelerating or braking, through which the load variables monitored by the logic unit change, it can happen that a gear determination made shortly beforehand proves to be inexpedient and the logic unit has to revise it.

From DE 199 46 560 A1 a gear selection device for an automatic or automated change-speed transmission is known, which initially indicates a determined gear to a driver in order to offer him the possibility to prevent a shifting operation planned by the gear selection device when he does not consider it practical. In this way, the fact is utilized that the driver is already aware of the control maneuvers with which he reacts to the traffic situation even before their execution and that based on this knowledge he is able to evaluate if a shifting operation planned by the gear selection device is practical or not.

Such a gear selection device brings about an additional load rather than a relief of the driver since he is held to continuously monitor the gear selection device and the need for stopping impractical shifting operations primarily occurs when the attention of the driver is already taken up by a rapid control maneuver.

In order to prevent inexpedient shifting operations, there is also the possibility of entirely foregoing an automatic or automated shifting of the gears and merely employ a gear selection device of the type described above for supplying proposals for a gear that is appropriate for the current engine load, leaving it to the driver if he manually engages the proposed gear or not. Although such a gear selection device can make it easier for the driver to travel in a fuel-saving manner, but since ultimately every shifting operation has to be carried out manually, the load on the driver is not substantially less than with a motor vehicle having a purely manual gear shift. In addition, the problem that shifting recommendations given by the gear selection device at the time at which they are supplied can already be obsolete because of changes of the traffic situation to which the driver has to react and which are merely perceived by the driver as impractical lecturing also exists here. In order to make it possible that the driver can actually take the shifting recommendations of such a gear selection device seriously when these are justified, it is necessary to avoid evidently inexpedient shifting recommendations.

Therefore it may be desirable to provide a gear selection device which largely avoids the gear selections, which in hindsight do not prove to be practical and have to be reversed again in the short term, from the start. In addition, other objects, desirable features and characteristics will become apparent from the subsequent summary and detailed description, and the appended claims, taken in conjunction with the accompanying drawings and this background.

### SUMMARY

Accordingly, various aspects of the present disclosure provide a gear selection device for a motor vehicle having logic unit that is equipped to determine a gear to be engaged in a transmission of the motor vehicle from at least one variable connected to the load of an engine of the motor vehicle, the gear selection device furthermore comprises an ambient area sensor and is equipped to take into account an item of information relating to the road located in front of the vehicle supplied by the ambient area sensor when outputting a selection signal specifying a newly determined gear. In this manner, the information status on the basis of which the gear selection device generates the selection signal can be adjusted to the state of knowledge of the driver.

The gear selection device can be equipped to take into account items of information supplied by the ambient area sensor immediately when determining the gear specified in the selection signal. In this way, a maximum degree of comfort can be created for the driver—assuming a suitable intelligence of the gear selection device.

When the information indicates the presence of a traffic situation that requires a change of the speed of the motor vehicle, this can be taken into account by the gear selection device according to a simpler configuration of the present disclosure in that it suppresses the output of the selection signal in such a traffic situation. In other words, in a traffic situation which the gear selection device is unable to securely evaluate, generating no selection signal is better than an incorrect one.

Various types of such traffic situations can exist. A first of these types is for example a traffic situation in which the ambient area sensor senses the presence of an obstacle on the road in front of the vehicle. Such an obstacle can in particular be a second motor vehicle which travels on the same road as the vehicle equipped with the gear selection device according to the present disclosure. When the two vehicles approach each other it is evident that in order to avoid the collision the motor vehicle approaching from behind either has to slow down or overtake. In both cases, a clear speed change must be expected which will probably render a gear determination based on the current engine load obsolete.

According to another exemplary embodiment, the gear selection device is equipped to evaluate the time up to the reaching of the obstacle and to suppress the output of the selection signal only when this time undershoots a limit value. Thus it can be ensured that when steadily travelling in a line of traffic in which neither a braking nor an overtaking of the vehicle travelling in front is to be expected, the selection signal is output.

A further traffic situation which may require a change of the speed of the motor vehicle is the presence of a curve of the road ahead. This, too, can be sensed with the help of the ambient area sensor.

In order not to unnecessarily suppress the output of the selection signal it is practical if the gear selection device is able to evaluate if for safely travelling through the curve ahead a reduction of the vehicle speed is required, and to suppress outputting the selection signal only in this case.

The ambient area sensor can also be equipped to sense a traffic situation which requires a reduction of the speed of the motor vehicle to a target speed and to determine a new gear so that the target speed can be reached with efficient fuel consumption or comfortable driving sensation. A traffic situation can for example be a curve of the road ahead, for the travelling through without danger of which it can be practical to reduce the vehicle speed to the target speed by engaging a lower gear or the approaching of a vehicle travelling ahead with the target speed, which cannot be overtaken.

Possible ambient area sensors are for example direction-resolving or imaging sensors such as for example a camera or a radar. These can already be present in a motor vehicle for other purposes, for example within the scope of a lane departure warning system or a distance control system; the ambient area sensors can therefore be utilized also within the scope of the present disclosure with minimal additional costs.

If the traffic situation to be sensed relates only to geographical information such as for example the course and/or the incline of the road but not other road users, a vehicle navigation system can also serve as ambient area sensor which obtains information regarding the surroundings of the vehicle indirectly in the known manner from the linking of a stored map with received radio signals which make possible deducing the geographical position of the vehicle. The information of such a vehicle navigation system can also be utilized in order to verify information gained with another type of ambient area sensor.

The gear selection device can comprise a display instrument which receives the selection signal in order to display the determined gear to a driver. Such a display instrument is expedient in particular in connection with a manual shift in order to supply the driver with proposals for an efficient shifting. However, it can also be combined with an automatic or automated change-speed transmission in order to inform the driver of a planned shifting operation in advance, providing him with the possibility of adapting to this or take a countermeasure as required. In order to make it easier for the driver to detect that a gear has been newly determined by the gear selection device it can be provided that the display instrument displays this gear only if it differs from the gear currently engaged in the transmission of the vehicle.

The gear selection device can also comprise an actuator which receives the selection signal in order to automatically engage the determined gear in a transmission.

A person skilled in the art can gather other characteristics and advantages of the disclosure from the following description of exemplary embodiments that refers to the attached drawings, wherein the described exemplary embodiments should not be interpreted in a restrictive sense.

### BRIEF DESCRIPTION OF THE DRAWINGS

The various embodiments will hereinafter be described in conjunction with the following drawing figures, wherein like numerals denote like elements, and wherein:

FIG. 1 is a block diagram of a gear selection device according to the present disclosure;

FIG. 2 is a flow diagram of a working method of the gear selection device according to an exemplary embodiment of the present disclosure;

FIG. 3 is a flow diagram according to another exemplary embodiment; and

FIG. 4 is a flow diagram according to another exemplary embodiment.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

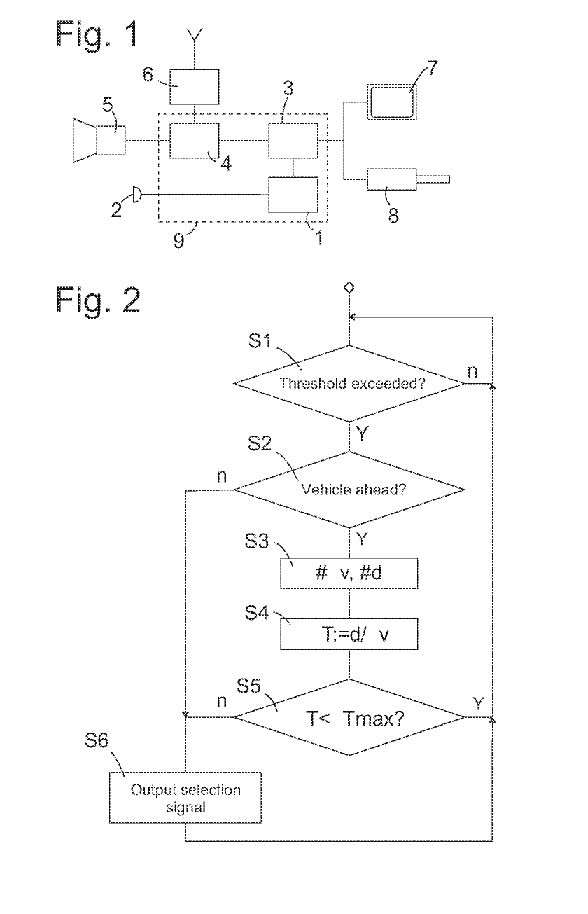

The gear selection device shown in FIG. 1 comprises a logic unit 1, which is connected to various sensors 2. The sensors 2 serve for sensing variables connected to the engine load of a motor vehicle in which the gear selection device is installed. The sensors 2 can comprise in one example, a rotational speed sensor for sensing the rotational speed of the engine and a speedometer, and the function of the logic unit 1 is to compare the current rotational speed supplied by the rotational speed sensor with shifting thresholds defined as function of the speed indicated by the speedometer and, when the exceeding of a shifting threshold is determined, output a gear change signal specifying a newly determined gear to suit the current values of rotational speed and speed to a higher-level unit 3. A further sensor 2 can for example be arranged on an accelerator pedal of the motor vehicle for sensing its position, wherein a rapid actuation of the accelerator pedal or a fully depressed position can be sensed by the sensor 2 and serve as trigger for the logic unit 1 in order to generate a gear change signal.

The higher-level unit 3 receives information also from an ambient area monitoring unit 4, which in turn has inputs connected to a camera 5 and a vehicle navigation system 6. The camera 5 is focused onto the road located in front of the vehicle in order to supply images of the course of the road and any other vehicles possibly moving on the road to the ambient area monitoring unit 4. The camera 5 can be a stereo camera which supplies pairs of images taken at slightly different viewing angles in order to enable the ambient area monitoring unit 4 to estimate the distance of the vehicle from objects that can be identified in the image pairs; alternatively, a mono-camera 5 for this purpose can also be alone or combined with other known distance measuring systems, for example on a radar basis.

Data supplied by the vehicle navigation system 6 regarding the course of the road ahead of the vehicle can be utilized by the ambient area monitoring unit 4 in order to check the plausibility of a course of a road estimated by means of the images of the camera 5 or facilitate the identification of the road in the images supplied by the camera 5. Likewise, the vehicle navigation system 6 can supply data regarding courses of curves and uphill and downhill gradients located ahead, which can be utilized in order to predict the engine load of the vehicle so that a shifting recommendation can be calculated taking into account future engine loads.

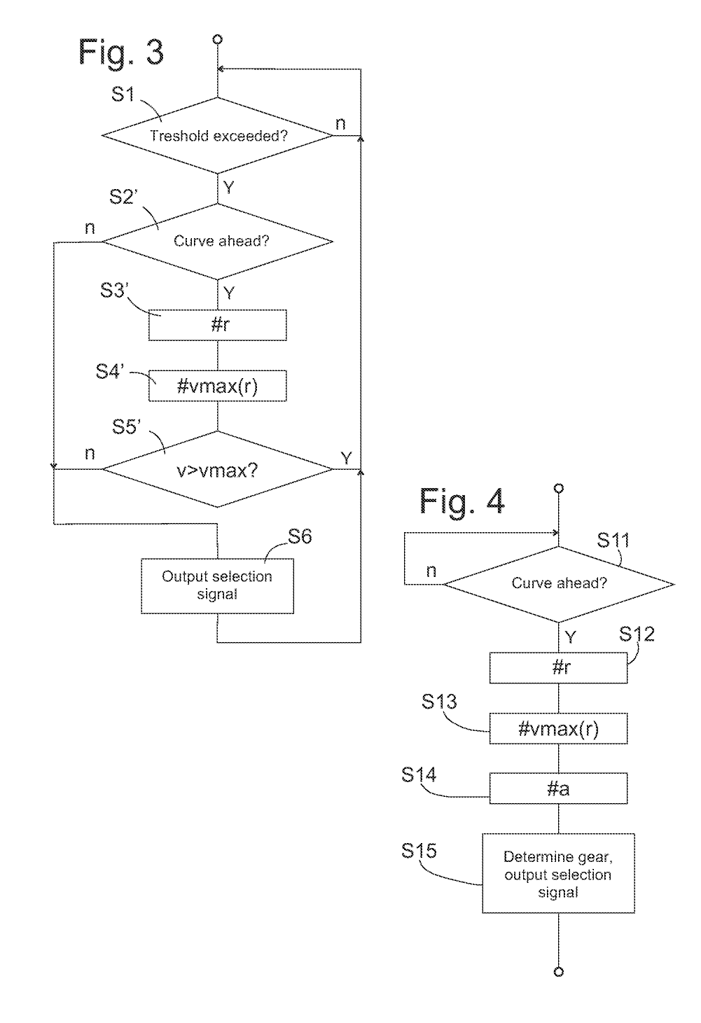

As is still explained in more detail by means of FIGS. 2 and 3 in the following, the ambient area monitoring unit 4 serves in order to assess and evaluate the traffic situation by means of the data supplied by the camera, if in the near future a severe speed change is to be expected which could render a new determination of the gear made by the logic unit 1, obsolete, and in this case to supply a blocking signal to the higher-level unit 3. Only if there is no such blocking signal will the higher-level unit 3 pass a gear selection signal output by the logic unit 1 on to a connected peripheral device.

As peripheral device, a display instrument 7 can be provided which shows the driver the determined gear in order to prompt said driver to engage it in the vehicle transmission. Practically, the display instrument 7 is only switched on for as long as the determined gear differs from the gear currently engaged in the change-speed transmission of the vehicle, and it switches off as soon as the driver engages the determined gear. Thus, the starting of the display instrument 7 draws the attention of the driver to a suggestion that he should make a gear change.

As peripheral device, an actuator 8 can also be provided which acts on the change-speed transmission of the vehicle in order to engage the gear determined by the logic unit 1 in the transmission in the manner known from automated change-speed transmissions which is therefore not described here without any action on the part of the driver.

In one exemplary embodiment of the present disclosure, the logic unit 1, the ambient area monitoring unit 4 and the higher-level unit 3 are implemented in the form of software capable of running on a uniform microprocessor system.

The mode of operation of this microprocessor system 9 according to a first configuration is explained by means of the flow diagram of FIG. 2.

The block S1 of the method shown in FIG. 2 corresponds to the contribution of the logic unit 1: when in the transmission a current gear is engaged, it is continuously monitored if the rotational speed of the engine has exceeded a shifting threshold to the next higher or next lower gear defined as a function of the vehicle speed. If yes, it is checked in block S2 if in the last image supplied by the camera 5 a vehicle travelling ahead can be identified or not. In order to improve the safety of such identification, images that are older than the respective latest image of the camera 5 can also be utilized in a supporting manner. If there is no vehicle travelling ahead in the image, the method jumps to block S6, in which a selection signal, identifying the newly determined gear in block S1, is output to the peripheral device 7 or 8.

If in block S2 a vehicle travelling ahead is identified, an assessment of the speed Δv follows in block S3, with which the two vehicles approach each other and of the distance d to the vehicle travelling ahead. By means of these two variables, the time span ΔT can be assessed in the next block S4, within which the vehicles would collide were it not for a change in the relative speed Δv. The shorter this time span ΔT is, the more probable it is that the driver will change the speed of the vehicle in the near future, be it through braking in order to avoid riding up on the vehicle travelling ahead or by accelerating in order to overtake it. In the case that ΔT undershoots a predetermined limit value, this can also be used as trigger in order to generate a visual or acoustic warning signal, thus prompting the driver to adjusting his speed.

In block S5, again a comparison with a limit value ΔTmax takes place, which is generally greater than the abovementioned limit value of the warning signal. If ΔT undershoots this limit value ΔTmax, in other words a change of the vehicle speed is required within the time ΔTmax, the method directly jumps back to the starting point S1 without outputting the selection signal in block S6. In other words, if the peripheral device is the display instrument 7, the driver will not be shown the newly determined gear by the logic unit 1 so that an irritation of the driver through a changing or starting of the display instrument 7 at a time at which he has to focus his entire attention to the traffic in front of him, is avoided. In the case that the peripheral device is the actuator 8, a shifting operation is suppressed in this manner which would come in the way of a short-term acceleration of the vehicle and which after a change of the vehicle speed, irrespective of whether towards higher or lower values, would have to be corrected anyway with a high degree of probability.

FIG. 3 shows a flow diagram of a working method that can be carried out in the microprocessor system 9 alternatively or also additionally to the method of FIG. 2. The block S1 is the same as in the method of FIG. 2. In block S2′, the respective latest images of the camera 5 are analyzed as to whether the road located in front of the vehicle comprises a curve. If this is not the case, the method jumps to block S6 which in turn is the same as in the method of FIG. 2. In order to be able to identify a curve located ahead by the camera 5 even in the case of possibly ambiguous or missing information, map data supplied by the vehicle navigation system 6 can be used as help. In one example, in the case of a fork in the road visible in the images of the camera 5, information of the navigation system 6 regarding a planned trip route can be utilized in order to decide which of the forking roads will probably be taken and in this manner take into account a curve that is visible in the images of the camera 5 only when it belongs to the planned trip route. Likewise, information regarding uphill and downhill gradients can also be taken into account.

If in block S2′ a curve of the road was identified, which the vehicle will probably follow, the radius r of this curve is estimated in block S3′. Such an estimation can be based alone on the evaluation of the images supplied by the camera; however, map data of the navigation system 6 regarding curves on the road of the vehicle and their radii can be utilized in order to generate, correct or render more precisely such an estimation.

In block S4′, a maximum speed vmax(r) is estimated by means of the estimated radius r which should not be exceeded for the safe negotiating of the curve. For such an estimation, information gained from the images of the camera regarding the width of the road and climate data, for example from a precipitation sensor, can be additionally utilized for example in order to set the limit speed vmax lower in the case of precipitations than with a dry road.

In block S5′, the limit speed vmax is compared to the current vehicle speed v. If v is higher, the driver has to foreseeably decelerate the vehicle in order to negotiate the curve. In this case, the output of the selection signal to the peripheral device 7 or 8 is suppressed and the method directly returns to the start; it can be provided that in this case a warning signal is generated in order to prompt the driver to reduce the speed. If however the current speed v is below the limit value vmax, an adjustment of the speed for negotiating the curve is not necessary and the selection signal can be output in block S6.

Obviously, the methods of FIGS. 2 and 3 can also run combined in a same gear selection device.

According to another exemplary embodiment of the method of FIG. 2 the information regarding courses of curves and gradients of the road located ahead can already be utilized for the gear selection in block S1, for example in that for the decision as to whether the shifting threshold is exceeded, the current value of the engine rotational speed is not utilized or not only utilized but also a future value estimated by means of the information regarding the course of the road.

Another exemplary embodiment of the working method shown in FIG. 4 does not presuppose any continuous monitoring of the shifting thresholds, instead, an analysis of the images of the camera 5 regarding curves noticeable therein continuously takes place for as long as the vehicle is at idle speed or in coasting mode. An estimation of the radius r and of the maximum safe negotiating speed vmax takes place in the blocks SF12, S13 in the same manner as described with respect to the blocks S3′, S4′ of FIG. 3. Knowing the distance to the curve and if applicable of a difference of level to be overcome up to the curve, the difference between vmax and the current speed v produces a brake deceleration a that is required in order to bring the vehicle to a speed of vmax or less up to the point of reaching the curve which allows safe negotiating of the curve. Based on this deceleration value a, a gear is determined in block S15 which allows reaching this deceleration in coasting mode and a selection signal is output to the peripheral device 7 or 8 in order to prompt the driver to engage this gear or engage it automatically depending on the type of the peripheral device.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

What is claimed is:

1. A gear selection device for a motor vehicle, comprising:
a logic unit that determines a gear to be engaged in a transmission of the motor vehicle by means of at least one variable connected to the load of an engine of the motor vehicle; and
an ambient area sensor,
wherein the gear selection device takes into account information relating to the road located in front of the vehicle supplied by the ambient area sensor when outputting a selection signal specifying a newly determined gear.

2. The gear selection device according to claim 1, wherein the gear selection device is equipped in order to take into account information supplied by the ambient area sensor with the determining of the gear specified in the selection signal.

3. The gear selection device according to claim 1, wherein the gear selection device senses at least one traffic situation which makes a change of the speed of the motor vehicle necessary and in such at least one traffic situation, suppresses outputting the selection signal.

4. The gear selection device according to claim 3, wherein the at least one traffic situation requires a change of the speed of the motor vehicle, and the gear selection device senses the presence of an obstacle on the road.

5. The gear selection device according to claim 4, wherein the gear selection device evaluates the time up to the reaching of the obstacle and suppresses the outputting of the selection signal only when this time undershoots a limit value.

6. The gear selection device according to claim 5, wherein the at least one traffic situation would require a changing of the speed of the motor vehicle, and the gear selection device senses the presence of a curve of the road located ahead.

7. The gear selection device according to claim 6, wherein the gear selection device is equipped to suppress the outputting of the selection signal only when it deems a braking of the vehicle necessary for negotiating the curve located ahead.

8. The gear selection device according to claim 1, wherein the gear selection device is equipped to sense a traffic situation which requires a reduction of the speed of the motor vehicle to a target speed, and to determine a new gear so that the target speed is reached.

9. The gear selection device according to claim 1, wherein the ambient area sensor further comprises at least one of a camera, a radar and a navigation system.

10. The gear selection device according to claim 1, wherein the ambient area sensor is equipped to supply information regarding uphill or downhill gradients of the road.

11. The gear selection device according to claim 1 wherein the gear selection device further comprises a display instrument which receives a selection signal in order to display the determined gear.

12. The gear selection device according to claim 11, wherein the display instrument displays the determined gear only when it differs from the gear currently engaged in a connected transmission.

13. The gear selection device according to claim 12, wherein the gear selection device further comprises an actuator which receives the selection signal in order to engage the determined gear in a transmission.

14. A motor vehicle, comprising:
a gear selection device that includes a logic unit that determines a gear to be engaged in a transmission of the motor vehicle by means of at least one variable connected to the load of an engine of the motor vehicle;
an ambient area sensor; and
a display instrument which receives a selection signal in order to display the determined gear,
wherein the gear selection device takes into account information relating to the road located in front of the vehicle supplied by the ambient area sensor when outputting a selection signal specifying a newly determined gear.

15. The motor vehicle according to claim 14, wherein the display instrument displays the determined gear only when it differs from the gear currently engaged in a connected transmission.

16. The motor vehicle according to claim 15, wherein the gear selection device further comprises an actuator which receives the selection signal in order to engage the determined gear in a transmission.

17. The motor vehicle according to claim 14, wherein the gear selection device is equipped to sense a traffic situation which requires a reduction of the speed of the motor vehicle to a target speed, and to determine a new gear so that the target speed is reached.

18. The motor vehicle according to claim 14, wherein the ambient area sensor further comprises at least one of a camera, a radar and a navigation system.

19. The motor vehicle according to claim 14, wherein the gear selection device is equipped in order to take into account information supplied by the ambient area sensor with the determining of the gear specified in the selection signal.

20. The motor vehicle according to claim 14, wherein the gear selection device senses at least one traffic situation which makes a change of the speed of the motor vehicle necessary and in such at least one traffic situation, suppresses outputting the selection signal.
